(19) United States
(12) Patent Application Publication
(10) Pub. No.: US 2020/0318792 A1
(43) Pub. Date: Oct. 8, 2020

(54) AIR COOLER FOR DISCHARGING COLD OXYGEN

(71) Applicant: Jae Ha SONG, Daegu (KR)

(72) Inventor: Jae Ha SONG, Daegu (KR)

(21) Appl. No.: 16/630,552

(22) PCT Filed: Jul. 13, 2018
(86) PCT No.: PCT/KR2018/007941

§ 371 Date: Jan. 13, 2020

(30) Foreign Application Priority Data
Jul. 13, 2017 (KR) 10-2017-0088966

(51) Int. Cl. F17C 7/04

(52) U.S. Cl. CPC F17C 7/04; F24F 5/0007

(57) ABSTRACT

Disclosed is an air cooler, of which a body unit is provided with a cold air generating unit having a cryogenic oxygen transfer tube to discharge cold air, without using a vaporizer for an oxygen container for supplying cold oxygen, thereby simplifying a construction of the oxygen container, which results in decreased costs and improved cooling efficiency. The air cooler includes a body unit (10) for discharging a cold oxygen gas; and an oxygen container (20) for supplying a cryogenic oxygen gas to the body unit (10). The body unit (10) discharges the oxygen gas, which is supplied from the oxygen container (20) through a cold air outlet (11) which is provided to an upper end of the body unit (10), in cooperation with a flow fan (13). The cold air outlet (11) is provided therein with a cold air generator (31) which includes a transfer tube (30), the transfer tube being spiraled in a circular or rectangular shape, and a discharge portion (32) which is the end of the cold air generator is disposed to face the cold air outlet (11).

### TECHNICAL FIELD

The present invention relates to an air cooler for discharging cold oxygen, and more particularly, to an air cooler, of which a body unit is provided with a cold air generating unit having a cryogenic oxygen transfer tube to discharge cold air, without using a vaporizer for an oxygen container for supplying cold oxygen, thereby simplifying a construction of the oxygen container, which results in decreased costs and improved cooling efficiency.

### BACKGROUND ART

As disclosed in Korean Patent Nos. 10-1614099, 10-1666183 and 10-1643396, when cryogenic liquid oxygen filled in an oxygen container is outwardly discharged therefrom, an air cooler discharges cold oxygen gas to carry out a function of blowing cold air, and supplies oxygen of high purity to improve metabolism of a human body by clean air.

Such an air cooler includes a body unit for discharging the cold oxygen, and an oxygen container for supplying the cryogenic oxygen gas to the body unit. The body unit discharges the cryogenic oxygen gas supplied from the oxygen container through a cold air blower which is provided to an upper end of the body unit.

The oxygen container is configured to supply the cryogenic oxygen gas to the body unit through the cryogenic oxygen transfer tube, and is installed inside the body unit or is separately installed to the outside.

As illustrated in FIGS. 1 and 2, an oxygen container 100 includes a first container 110 filled with liquid oxygen, a vaporizer 120 with a thin pipe enclosing an outer peripheral surface of the first container 110 in a spiral shape, in which the liquid oxygen filled in the first container 110 is discharged through the pipe, a second container 130 enclosing the first container 110 and the vaporizer 120, with the inside being maintained in a vacuum state, and at least one third container 140 enclosing the second container 130, with the third container being spaced apart from the second container 130.

The vaporizer 120 vaporizes the liquid oxygen when the liquid oxygen filled in the first container 110 passes through the pipe. The pipe of the vaporizer 120 encloses the outer peripheral surface of the first container 110 in the spiral shape. One end of the pipe, i.e., a lower end 121, is welded to a lower lateral hole 112 of the first container 110, while the other end of the pipe, i.e., an outlet tube 122, is vertically formed in parallel with a filling tube 115 of the first container 110.

The oxygen container 100 of the related art is formed of multiple containers, and is provided with the vaporizer 120, so that the configuration is complicated to raise a manufacturing cost and also increase the weight of a product.

### DISCLOSURE

### Technical Problem

Accordingly, the present invention has been made in view of the above-mentioned problem, and one object of the present invention is to provide an air cooler, of which a body unit is provided with a cold air generating unit having a cryogenic oxygen transfer tube to discharge cold air, without using a vaporizer for an oxygen container for supplying cold oxygen, thereby simplifying a construction of the oxygen container, which results in decreased costs and improved cooling efficiency.

### Technical Solution

To accomplish the above-mentioned object, according to one aspect of the present invention, there is provided an air cooler for discharging cold oxygen including a body unit for discharging a cold oxygen gas, and an oxygen container for supplying the cryogenic oxygen gas to the body unit, wherein the body unit discharges the oxygen gas, which is supplied from the oxygen container through a cold air outlet which is provided to an upper end of the body unit, in cooperation with a flow fan.

The cold air outlet is provided therein with a cold air generator which includes a transfer tube, the transfer tube being spiraled in a circular or rectangular shape, and a discharge portion which is the end of the cold air generator is disposed to face the cold air outlet.

Preferably, the cold air generator is fixed to a mesh-type fixture by a fastening member so that the cold air generator is maintained in the spiral shape.

Preferably, the transfer tube of the oxygen container is provided with an anti-frost tube for covering the cryogenic oxygen transfer tube 30 to prevent formation of frost.

### Advantageous Effects

With the configuration of the air cooler according to the invention, the body unit is provided with the cold air generating unit having the cryogenic oxygen transfer tube to discharge cold air, without using a vaporizer for an oxygen container for supplying cold oxygen, thereby simplifying the construction of the oxygen container, which results in decreased costs and improved cooling efficiency

### DESCRIPTION OF DRAWINGS

FIG. 1 is a cross-sectional view illustrating an oxygen filling device for an air cooler according to the related art;

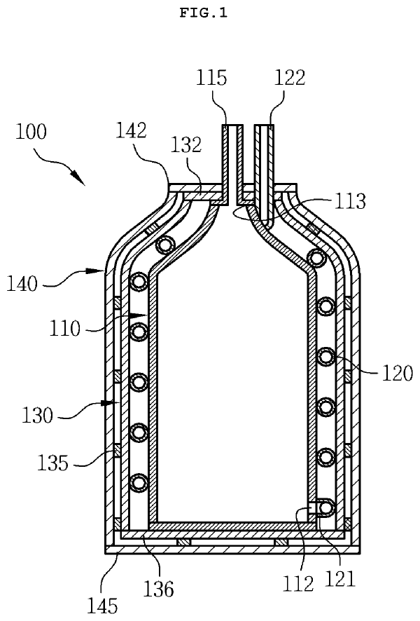

FIG. 2 is an exploded perspective view illustrating the oxygen filling device for the air cooler according to the related art;

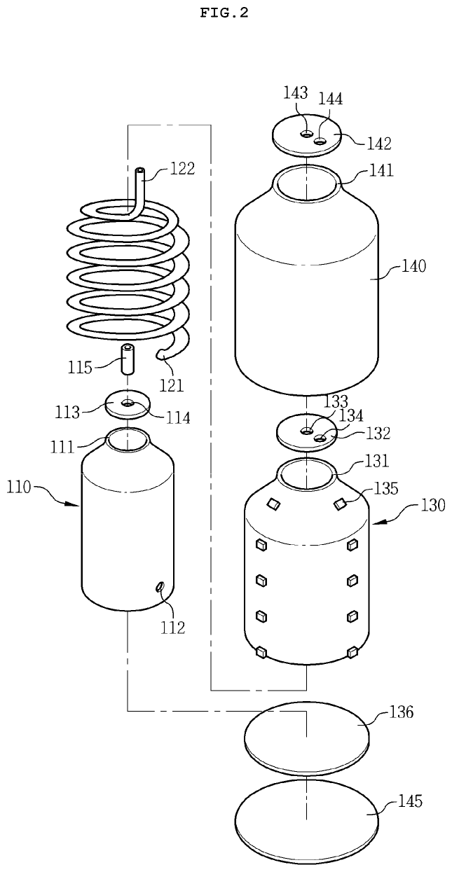

FIG. 3 is a view illustrating an air cooler for discharging cold oxygen according to one embodiment of the invention;

FIG. 4 is a cross-sectional view illustrating the air cooler for discharging the cold oxygen according to one embodiment of the invention; and

FIG. 5 is an enlarged view illustrating a major part of the air cooler for discharging the cold oxygen according to one embodiment of the invention.

### MODE FOR INVENTION

Hereinafter, preferred embodiments of the invention will be described in detail with reference to the accompanying drawings.

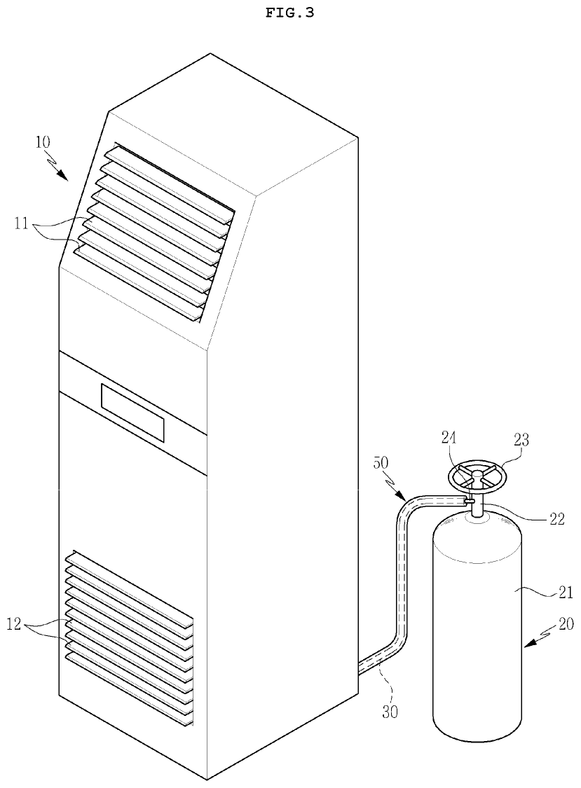

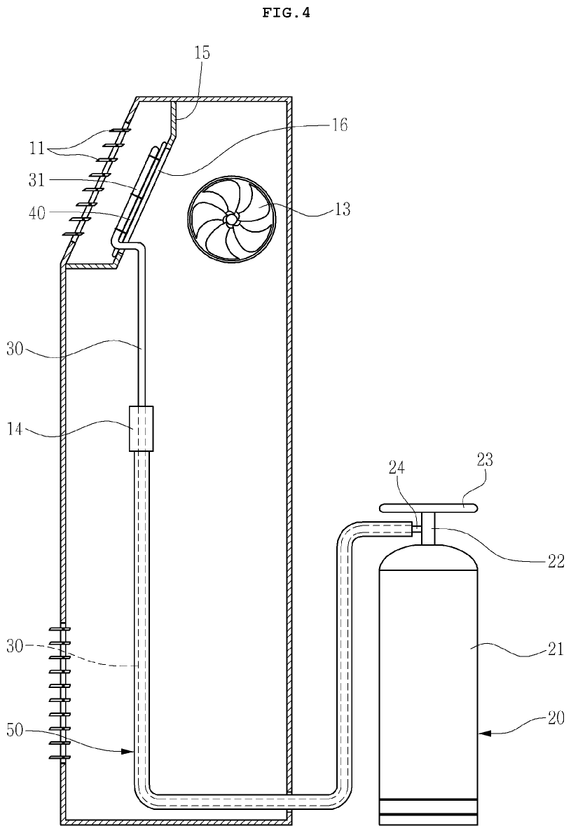

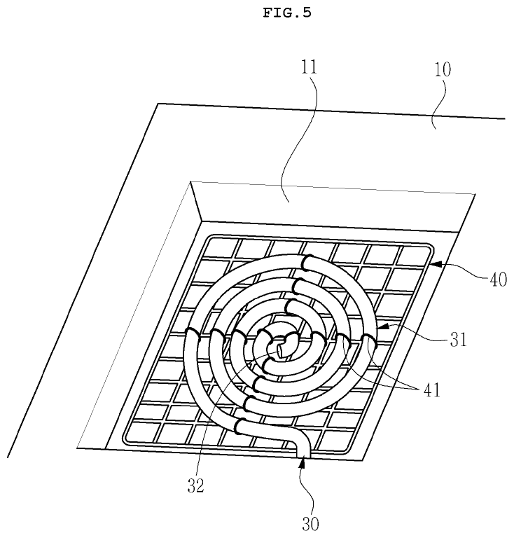

FIG. 3 is a view illustrating an air cooler for discharging cold oxygen according to one embodiment of the invention. FIG. 4 is a cross-sectional view illustrating the air cooler for discharging the cold oxygen according to one embodiment of the invention. FIG. 5 is an enlarged view illustrating a major part of the air cooler for discharging the cold oxygen according to one embodiment of the invention.

As illustrated in FIGS. 3 to 5, the air cooler for discharging the cold oxygen according to the embodiment of the invention includes a body unit 10 and an oxygen container 20 for supplying the cryogenic oxygen gas to the body unit 10.

The body unit 10 discharges the oxygen gas supplied from the oxygen container 20 through a cold air outlet 11 which is provided to an upper end of the body unit.

The body unit 10 includes a cryogenic oxygen transfer tube 30 connected to the oxygen container 20, as illustrated in FIG. 4, and connected to one end of a mass control member 14 for adjusting an output of the oxygen gas, and the other end of the mass control member 14 forms a cold air generator 31 through the cryogenic oxygen transfer tube 30.

The cold air generator 31 is positioned near the cold air outlet 11, and is formed of the cryogenic oxygen transfer tube 30 which is spiraled in a circular or rectangular shape. A discharge portion 32 which is the end of the cold air generator is disposed to face the cold air outlet 11.

The cold air generator 31 is fixed to a mesh-type fixture 40 by a fastening member 41 so that the cold air generator keeps the spiral shape.

The body unit 10 includes a support frame 15 with an opening 16 toward the inside of the cold air outlet 11. The fixture 40 with the cold air generator 31 being installed thereto is fixed to the support frame 15.

The cold air generator 31 is formed to have the spiral structure, and is heat-exchanged with atmosphere by a flow of the cold oxygen, so that ambient temperature is kept at a very low level.

A blow fan 13 is disposed at a rear surface of the cold air generator 31, and thus the cold air generated from the cold air generator 31 and the cold air discharged from the discharge portion 32 are distributed through the cold air outlet 11 by the flowing of the blow fan 13.

The oxygen container 20 is configured to supply the cryogenic oxygen gas to the body unit 10 through the cryogenic oxygen transfer tube 30, and is installed inside the body unit 10 or is separately installed to the outside.

The oxygen container 20 includes an inlet pipe 22 formed at an upper end of a liquid oxygen container 21 filled with the liquid oxygen LOX, and an outlet pipe 24 branched from one side of the inlet pipe 22 and connected to the cryogenic oxygen transfer tube 30 to supply the oxygen gas.

The term ‘liquid oxygen’ means oxygen of a pale blue color which is cryogenic below −183° C.

The cryogenic oxygen transfer tube 30 of the oxygen container 20 is provided with an anti-frost tube 50 for covering the cryogenic oxygen transfer tube 30.

The anti-frost tube 50 has a heating function to prevent formation of front on the surface of the cryogenic oxygen transfer tube 30 due to the cold oxygen flowing through the cryogenic oxygen transfer tube 30.

The operation of the air cooler for discharging the cold oxygen according to the embodiment of the invention will not be described.

If a valve 23 of the oxygen container 20 is opened, the liquid oxygen filled in the liquid oxygen container 21 is supplied to the mass control device 14 of the body unit 10, which is a standby state, through the inlet pipe 22, the outlet pipe 24, and the cryogenic oxygen transfer tube 30.

In this instance, the frost is formed on the surface of the transfer pipe 30 due to temperature difference between the atmosphere and the liquid oxygen, while the cryogenic liquid oxygen is passing through the transfer pipe 30.

However, the surface temperature of the cryogenic oxygen transfer tube 30 is raised by the anti-frost tube 50 provided on the outside of the cryogenic oxygen transfer tube 30, thereby preventing formation of the frost.

If an operation switch is pushed down in this state, the mass control device 14 is opened, and then the liquid oxygen is discharged through the cryogenic oxygen transfer tube 30, and simultaneously the flow fan 13 is operated to ventilate the oxygen through the cold air outlet 11.

In this instance, the liquid oxygen flowing through the cryogenic oxygen transfer tube 30 is vaporized through heat exchange with the cold air generator 31, and thus is converted into a cold oxygen gas which is discharged through the discharge portion 32.

Therefore, the cold air generated by the heat exchange around the cold air generator 31 is mixed with the cold oxygen gas discharged through the discharge portion 32 of the cold air generator 31, and the mixed cold air is strongly discharged through the cold air outlet 11 by the ventilation of the blow fan 13.

The air cooler of the invention eco-friendly supplies the oxygen, different from an existing air conditioner using a freon gas as a refrigerant. Also, since the air cooler of the invention does not employ a vaporizer for the oxygen container 20, the volume of the apparatus is decreased, and thus the construction of the oxygen container is downsized, as well as improving cooling efficiency.

1. An air cooler for discharging cold oxygen comprising:
a body unit for discharging a cold oxygen gas; and
an oxygen container for supplying a cryogenic oxygen gas to the body unit,
wherein the body unit discharges the oxygen gas, which is supplied from the oxygen container through a cold air outlet which is provided to an upper end of the body unit, in cooperation with a flow fan, and
the cold air outlet is provided therein with a cold air generator which includes a transfer tube, the transfer tube being spiraled in a circular or rectangular shape, and a discharge portion which is the end of the cold air generator is disposed to face the cold air outlet.

2. The air cooler for discharging the cold oxygen according to claim 1, wherein the cold air generator is fixed to a mesh-type fixture by a fastening member so that the cold air generator is maintained in the spiral shape.

3. The air cooler for discharging the cold oxygen according to claim 1, wherein the transfer tube of the oxygen container is provided with an anti-frost tube for covering the cryogenic oxygen transfer tube to prevent formation of frost.
